(19) United States
(12) Patent Application Publication
(10) Pub. No.: US 2010/0327750 A1
(43) Pub. Date: Dec. 30, 2010

(54) LED ILLUMINATING APPARATUS

(75) Inventors: CHIH-CHUNG TSAO, Chu-Nan (TW); PING-YU CHEN, Chu-Nan (TW); KUO-FENG CHIANG, Chu-Nan (TW); YING-CHIEH LU, Chu-Nan (TW); SUNG-HSIANG YANG, Chu-Nan (TW); HSIN-FEI HUANG, Chu-Nan (TW); ZHENG-JAY HUANG, Chu-Nan (TW); YU-PIN LIU, Chu-Nan (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan (TW)

(21) Appl. No.: 12/695,999

(22) Filed: Jan. 28, 2010

(30) Foreign Application Priority Data
Jun. 25, 2009 (CN) 200910303649.X

(51) Int. Cl. H01J 13/32; F21V 29/00

(52) U.S. Cl. 315/113; 362/294

(57) ABSTRACT

An LED illuminating apparatus includes a lampshade, a cover engaged with the lampshade, a heat dissipation module received in a hollow tube cooperatively formed by the engaged lampshade and cover, a light source engaged on the heat dissipation module, and two connectors secured at opposite ends of the lampshade and the cover. The lampshade defines a plurality of vents therein. The light source faces the cover and light emitted from the light source radiates out of the LED illuminating apparatus through the cover.

### BACKGROUND

1. Technical Field

The present disclosure generally relates to LED illuminating apparatuses, and particularly to a tubular LED illuminating apparatus with a great heat dissipating capability.

2. Discussion of Related Art

Light emitting diodes (LEDs) are one kind of semiconductor element. Nowadays, LEDs are extensively used as light sources for illuminating apparatuses, due to their high luminous efficiency, low power consumption and long work life.

An LED illuminating apparatus, for example, an LED lamp generally requires a plurality of LEDs, and most of the LEDs are driven at the same time, which results in a quick rise in temperature of the LED lamp. Since generally the LED lamps do not have heat dissipation devices with good heat dissipating efficiencies, operation of the conventional LED lamp has a problem of instability because of the rapid increase of heat. Especially, an LED light tube which has a shell made of plastic or glass, which degrades the heat dissipation efficiency. If the LED lamp is used in a state of high temperature for a long time, the life time thereof is dramatically shortened. Furthermore, the shell for the LED light tube is generally a closed tube, whereby assembly thereof is difficult.

Therefore, what is needed is an LED illuminating apparatus which can overcome the above described shortcomings

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an assembled view of an LED illumination apparatus in accordance with a first embodiment of the present disclosure.

FIG. 2 is an exploded view of the LED illumination apparatus of FIG. 1.

FIG. 3 is a cross-sectional view of the LED illumination apparatus of FIG. 1, taken along line III-III thereof.

FIG. 4 is an assembled view of an LED illumination apparatus in accordance with a second embodiment of the present disclosure.

FIG. 5 is an exploded view of the LED illumination apparatus of FIG. 4.

FIG. 6 is a cross-sectional view of the LED illumination apparatus of FIG. 4, taken along line VI-VI thereof.

### DETAILED DESCRIPTION OF EMBODIMENTS

Reference will now be made to the drawings to describe various embodiments of the present LED illuminating apparatus in detail.

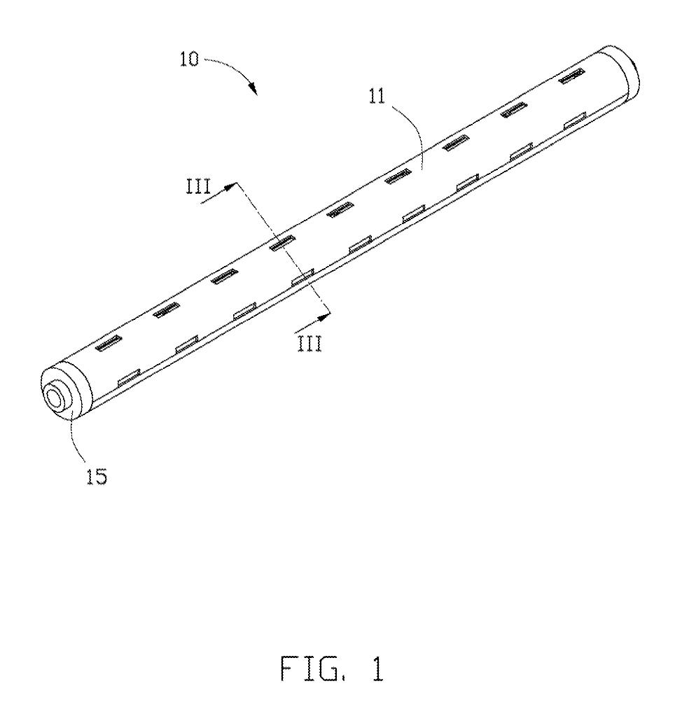

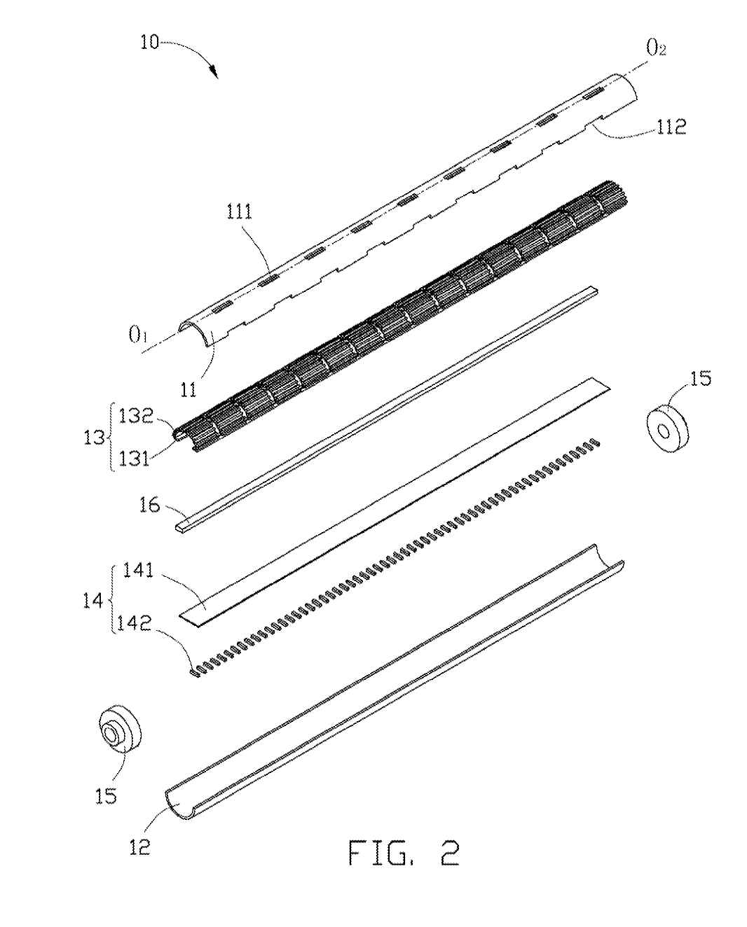

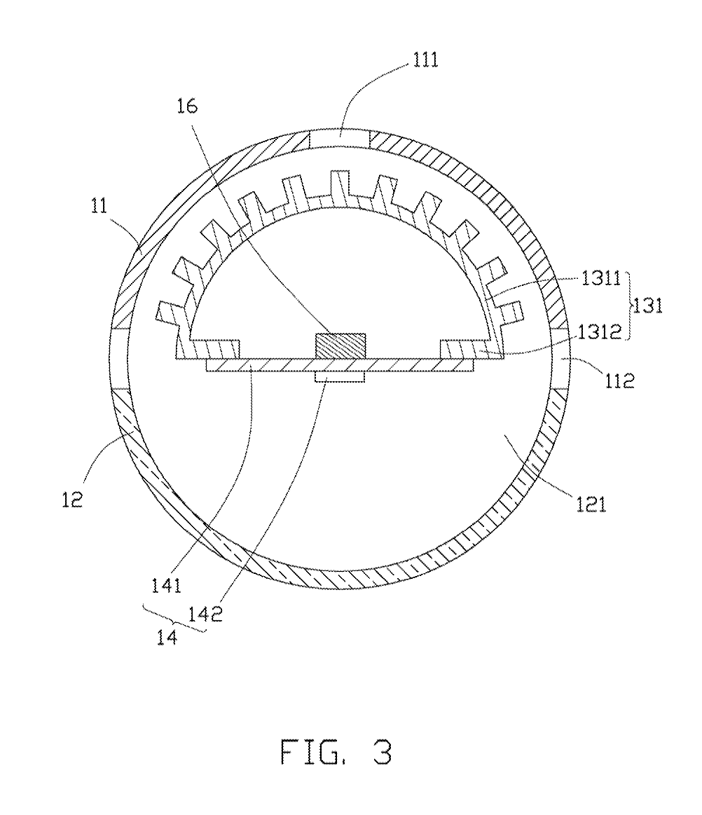

Referring to FIGS. 1-3, an LED illuminating apparatus 10, in accordance with a first embodiment, which is an LED light tube, includes a lampshade 11, a light transmitting cover 12 engaged with a bottom of the lampshade 11, a heat dissipation module 13 received in a tube cooperatively formed by the connected lampshade 11 and cover 12, a light source 14 engaged on the heat dissipation module 13, and two connectors 15 secured at two opposite ends of the lampshade 11 and the cover 12.

The lampshade 11 has a semi-cylindrical shape and defines a plurality of vents 111 at a top thereof and grooves 112 at two lateral sides thereof. The vents 111 arranged on a center line O₁O₂ of the lampshade 11, and the grooves 112 are symmetrically defined about the central line O₁O₂. In this embodiment, the vents 111 each are rectangular. The grooves 112 each are also rectangular. It can be understood that the vents 111 and grooves 112 may be in a shape of sector or circle, etc. The lampshade 11 is made of a material with a good heat conductivity, such as copper or aluminum.

The cover 12 has a semi-cylindrical shape and engaged with the lampshade 11 to form the tube. The grooves 112 of the lampshade 11 engaged with lateral sides of the cover 12 to form a plurality of through holes which communicating with ambient air. The cover 12 is transparent or light pervious, such as glass, plastic, or other transparent/translucent material.

The heat dissipation module 13 is received in the hollow tube defined by the lampshade 11 and the cover 12. In this embodiment, the heat dissipation module 13 is integrally extruded by a metal block. The heat dissipation module 13 includes a base 131 and a plurality of fins 132 extending the base 131 in arrays and spaced from each other. In this embodiment, the base 131 is generally arc-shaped, and includes a semicircular heat conductive portion 1311 and two supporting portions 1312 inwardly extending from two opposite ends of the heat conductive portion 1311. The fins 132 are projected upwardly from a convex surface of the base 131 along a longitudinal direction thereof and have a uniform extending height. Upper free ends of the fins 132 cooperatively form an imaginary semicircular, convex surface. Each of the supporting portions 1312 has a flat surface away from the convex surface of the base 131 and configured for supporting the light source 14.

The light source 14 received in the hollow tube includes a substrate 141 and a plurality of spaced LEDs 142 evenly mounted on the substrate 141 along a lengthwise direction of the substrate 141. The substrate 141 is securely attached to the flat surface of the supporting portions 1312. Each LED 142 is mounted in a thermally conductive relationship with the substrate 141. Light emitting from the LEDs 142 travels through the cover 12 to an outside of the LED illuminating apparatus 10 for lightening.

The connectors 15 are secured at the two opposite ends of tube cooperatively formed by the lampshade 11 and the cover 12, and configured for covering the two open axial ends of the hollow tube. The connectors 15 are provided for connecting with an external power source via two sockets (not shown) of a lamp holder (not shown) whereby the LEDs 142 can obtain the required electrical power for generating light. The connectors 15 are electrically connected with the LEDs 142. In the present embodiment, two ends of the base 131 respectively secured at inner surfaces of the connectors 15; therefore, the heat dissipation module 13 and the light source 14 can space a distance from inner surfaces of the lampshade 11 and the cover 12.

A driving circuit module 16 is arranged on one surface of the substrate 141 and opposite to the LEDs 142. The driving circuit module 16 electronically connects with the LEDs 142 and the connectors 15.

Heat generated by LEDs 142 is transferred to the fins 132 via the base 131, and dissipated to environment air through the lampshade 11. Furthermore, air in the hollow tube is heated by the LEDs 142 and then floats upwardly. The heated air escapes to the ambient atmosphere of the lampshade 11 via the vents 111 and the grooves 112 defined in the lampshade 11. Cooling air in the ambient atmosphere enters into the hollow tube, whereby a natural air convection is circulated between the hollow tube and the ambient atmosphere. Thus, the LED illuminating apparatus 10 with a great heat dissipating capability, and the brightness, lifespan, and reliability of the LED illuminating apparatus 10 will be improved. Also, the LED illuminating apparatus 10 has the lampshade 11 and the cover 12 engaged with the lampshade 11; therefore, the LED illuminating apparatus 10 is assembled more easily than the conventional LED light tube which has a shell with a configuration of a monolithic tube.

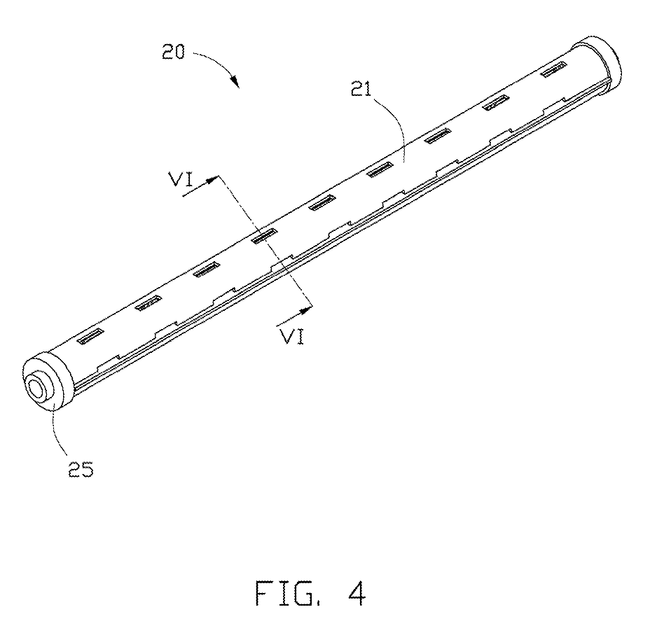

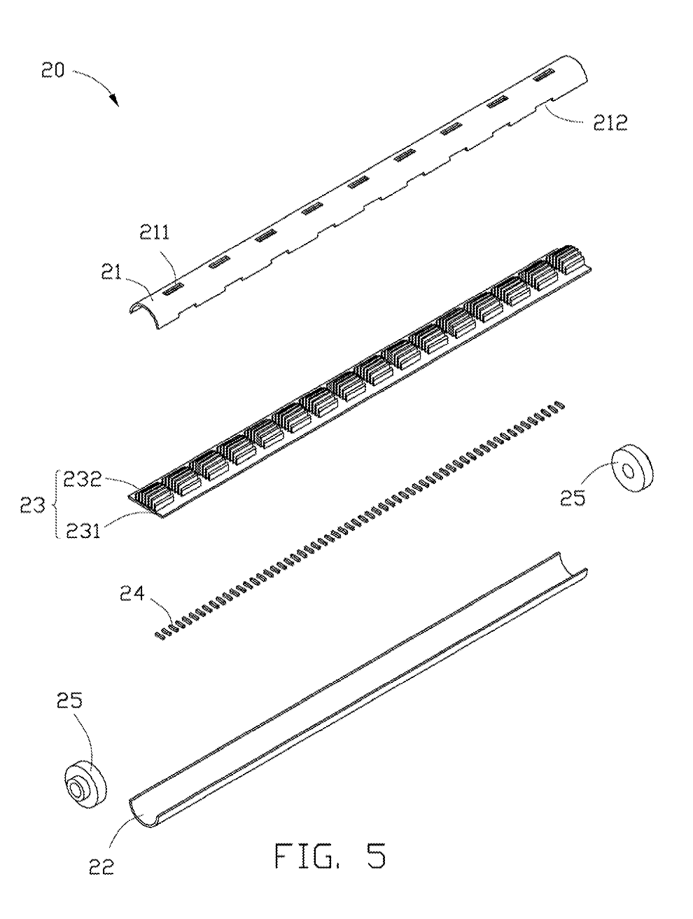

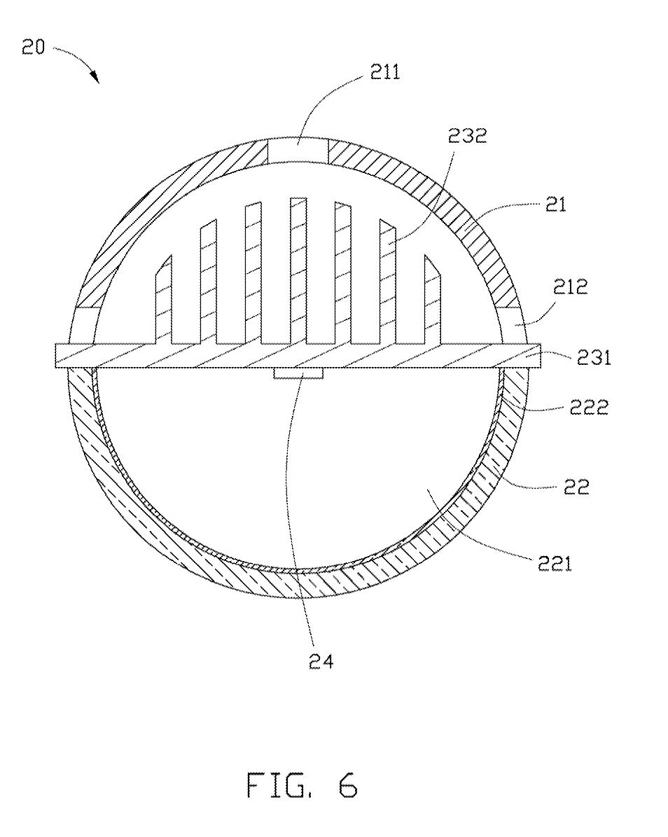

Referring to FIGS. 4-6, an LED illuminating apparatus 20, in accordance with a second embodiment, includes a lampshade 21, a cover 22 engaged with the lampshade 21. A heat dissipation module 23 is sandwiched between the lampshade 21 and the light penetrable cover 22. A light source 24 is engaged on the heat dissipation module 23. Two connectors 25 are secured at two opposite ends of the lampshade 21 and the cover 22.

The heat dissipation module 20 includes a flat base 231 and a plurality of fins 232 extending upwardly from the base 231 in arrays and spaced from each other. Heights of fins 232 gradually decrease along a center one of the fins 232 toward lateral sides of the fins 232. Upper free ends of the fins 232 cooperatively form an imaginary convex surface. Lateral sides of the base 231 is sandwiched between the lampshade 21 and the cover 22, and exposed to ambient air. The light source 24 can be selected from a packaged LED, an LED chip or an LED wafer consisting of a plurality of LED chips, which is mounted on one surface (i.e., bottom surface) of the base 231 facing the cover 22. In the present embodiment, a circuit is formed on the bottom face of the base 231 to which the light source 24 is electrically connected. The circuit is electrically connected with the connectors 25.

In the present embodiment, a light guide film 222 is formed on an inner surface of the cover 22. Light emitted from the light source 24 travels through the light guide film 222 uniformly. In other embodiments, the light guide film 222 can be formed on an outer surface of the cover 22, and a polarizing film or diffusion film can be formed on the inner surface of the cover 22.

It is to be further understood that even though numerous characteristics and advantages have been set forth in the foregoing description of embodiments, together with details of the structures and functions of the embodiments, the disclosure is illustrative only; and that changes may be made in detail, especially in matters of shape, size, and arrangement of parts within the principles of the disclosure to the full extent indicated by the broad general meaning of the terms in which the appended claims are expressed.

What is claimed is:

1. An LED illuminating apparatus comprising:
a lampshade defining a plurality of vents therein;
a cover cooperating with the lampshade to define a hollow tube, wherein the cover is light penetrable;
a heat dissipation module received in the hollow tube;
an LED light source received in the hollow tube and thermally contacting the heat dissipation module, the LED light source facing the cover and light emitted from the light source emitting out through the cover; and
two connectors being secured at two ends of the lampshade and the cover and configured for connecting exterior elements.

2. The LED illuminating apparatus of claim 1, wherein the LED light source comprises a substrate and a plurality of LEDs arranged on the substrate.

3. The LED illuminating apparatus of claim 1, wherein the heat dissipation module comprises a base and a plurality of fins on the base, the LED light source thermally contacting one surface of the base, the fins extending toward to the lampshade.

4. The LED illuminating apparatus of claim 3, wherein the base has a generally flat shape.

5. The LED illuminating apparatus of claim 4, wherein the heights of the fins are gradually decreased along a center one of the fins toward lateral sides of the fin, and upper free ends of the fins cooperatively forming an imaginary convex surface.

6. The LED illuminating apparatus of claim 3, wherein the lateral sides of the base are sandwiched between of the lampshade and the cover.

7. The LED illuminating apparatus of claim 3, wherein the base comprises a semicircular heat conductive portion and two supporting portions inward extending from two opposite ends of the heat conductive portion, the fins extending from the heat conductive portion and the LED light source thermally engaging the two supporting portions.

8. The LED illuminating apparatus of claim 7, wherein the fins have a uniform extending height and upper free ends of the fins cooperatively form an imaginary semicircular.

9. The LED illuminating apparatus of claim 7, wherein two ends of the heat conductive portion are secured at the two connectors respectively.

10. The LED illuminating apparatus of claim 7, wherein the LED light source is selected from the group consisting of a packaged LED, an LED chip and a LED wafer consisting of a plurality of LED chips, and the LED light source is mounted on the supporting portions.

11. The LED illuminating apparatus of claim 1, wherein the heat dissipation module comprises a flat base and a plurality of fins on the base mounted on the base, the lateral sides of the base being sandwiched between the lampshade and the cover.

12. The LED illuminating apparatus of claim 1, wherein the lampshade and the cover have semi-cylindrical shapes, the lampshade engaging the cover to form a hollow tube.

13. The LED illuminating apparatus of claim 1, wherein the vents of the lampshade define in a center line thereof and a plurality of grooves are symmetrical about the central line.

14. The LED illuminating apparatus of claim 1, wherein an optical film is formed on the cover.

15. The LED illuminating apparatus of claim 14, wherein the optical film is selected from the group of polarizing film, light guide film, or diffusion film.

16. The LED illuminating apparatus of claim 1, wherein the lampshade is made of a metal.

17. The LED illuminating apparatus of claim 1, wherein the cover is transparent.

18. The LED illuminating apparatus of claim 1, wherein the cover is made of one of glass and plastic.

19. The LED illuminating apparatus of claim 1, further comprising a driving circuit module being received in the hollow tube and electronically connecting with the LED light source.
